(19) United States
(12) Patent Application Publication
(10) Pub. No.: US 2016/0343405 A1
(43) Pub. Date: Nov. 24, 2016

(54) METHOD AND APPARATUS FOR CO-ORDINATING AND DISPLAYING HOW-TO VIDEOS

(71) Applicant: Skillionz Inc., St. Clements (CA)

(72) Inventor: John McELHONE, St. Clements (CA)

(21) Appl. No.: 15/157,911

(22) Filed: May 18, 2016

Related U.S. Application Data
(60) Provisional application No. 62/164,088, filed on May 20, 2015.

(51) Int. Cl. G11B 27/036; G09B 5/06; H04N 5/783; G11B 27/36; G11B 27/00; G09B 19/00; H04N 5/92

(52) U.S. Cl. CPC G11B 27/036; G09B 19/0038; G09B 5/065; H04N 5/9206; G11B 27/36; G11B 27/005; H04N 5/783

(57) ABSTRACT

The disclosure is directed at a method and apparatus for producing and displaying how-to videos. The production of the how-to video includes the functionality of the insertion of a coaching tip within the how-to video which allows a producer of the video to embed pauses and annotations within the video for a viewer.

### CROSS-REFERENCE TO RELATED APPLICATIONS

This application claims the benefit of U.S. Patent Application No. 62/164,088, filed May 20, 2015, the contents of which are incorporated herein by reference.

### FIELD OF THE DISCLOSURE

The current disclosure is directed generally to online videos and, more specifically, at a method and apparatus for co-ordinating and displaying how-to videos.

### BACKGROUND OF THE DISCLOSURE

Historically, when an individual wishes to learn how to perform a task, the individual can either ask someone to teach them how to perform the task or refer to a book which would provide the steps to achieve that task. With the popularity of online videos, users may now refer to online how-to videos to learn how to perform a task, such as, learning a new sport's skill.

Many existing online venues for viewing how-to videos provide an inconsistent format, poor categorization or both. An inconsistent format means that an individual is not sure about the quality of each how-to video. It is also likely that the individual is not sure how much value the individual may receive from watching the how-to video. For instance, some how-to videos are short with little substance while some are long and overly verbose. In other examples, the how-to videos may have unwanted voiceovers, music, annotation, slow motion, pauses, animation etc. Furthermore, poor categorization means that searching in a videos database yields unwanted results, especially when only free form text based searching is available.

Therefore, there is provided a novel method and system for co-ordinating and displaying how-to videos which overcome disadvantages of current systems.

### SUMMARY OF THE DISCLOSURE

The disclosure is directed at a method and apparatus for co-ordinating and displaying how-to videos. In one embodiment, the apparatus, or system, is provided in a single repository, such as a website, for the creation, posting, searching, sharing and viewing of how-to videos. These how-to videos will, preferably, be sports related, however, the current disclosure may also be beneficial in other fields where the teaching and learning of tasks are prevalent.

In a preferred embodiment, the how-to videos are concise such that they are less than a pre-determined time threshold, such as, but not limited to, 10 seconds of raw video footage. This will allow the how-to videos to distill down the skill, such as a sports skill, being taught to just their essence. In this manner, the how-to videos may be the very basics of what a viewer may need in order to review, visualize, attempt and master the skill.

Individual sports skills, or actions typically take no more than 10 seconds so in a preferred embodiment of the disclosure, the how-to videos are designed to provide instruction on these specific individual skills or actions. In one embodiment, each video includes short pauses, preferably five seconds in length, at key points in the teaching. The pauses are preferably accompanied by annotation or annotations to describe the movement as part of the skill.

To improve a user's ability or opportunity to locate the desired how-to video, the videos are categorized by a specific sport, discipline and skill. This categorization improves search functionality by leveraging the detailed categorization. By selecting a specific sport in one of the search tools, and then further refining the query with a specific discipline and/or skill, the disclosure provides search results that deliver the skills the viewer wants to learn.

In one aspect of the disclosure, there is provided a method of producing a how-to video displaying raw video footage to a producer and then inserting a coaching tip into the raw video footage. The raw video footage is then stored as a how-to video. Insertion of the coaching tip can be performed by sensing a request for coaching tip insertion and then transmitting an annotation text request to the producer. After receiving the annotation text, the annotation text is stored as a coaching tip within the how-to video.

In another aspect, the placement of the coaching tip within a display image of the how-to video is sensed and then stored by the system. In another aspect, before sensing the request for coaching tip insertion, the producer's navigation to a specific point in the how-to video is sensed. This assists the system in understanding when in the how-to video to show the coaching tip. In another aspect, the coaching tip is accompanied by a pause in the video play.

### BRIEF DESCRIPTION OF THE DRAWINGS

The following figures illustrate various aspects and embodiments of the system, method and apparatus disclosed herein:

FIG. 1 is a flowchart outlining a method of producing a how-to video according to an embodiment of the disclosure;

FIG. 2a is an example of a display screen for uploading raw video footage;

FIG. 2b is an example of a display screen for video editing;

FIGS. 2c to 2g are examples of display screens for inserting a coaching tip;

FIG. 3 is a flowchart outlining a method of providing a how-to video to a viewer;

FIG. 4a is an example of a display screen for an introduction video for a viewer;

FIG. 4b is an example of a display screen for user registration;

FIG. 4c is an example of a display screen for providing search functionality to a viewer;

FIGS. 4d to 4g are examples of a display screens of a how-to video viewer display;

FIG. 4h is an example of a display screen of social media interactivity for a viewer; and

FIG. 4i is an example of a display screen of producer's or coach's videos page.

### DETAILED DESCRIPTION OF DISCLOSURE

The disclosure is directed at a method and apparatus for producing and displaying how-to videos. In one embodiment, the apparatus provides a somewhat consistent format to the production of how-to videos such that viewers have a similar experience viewing videos provided by the method and apparatus of the disclosure.

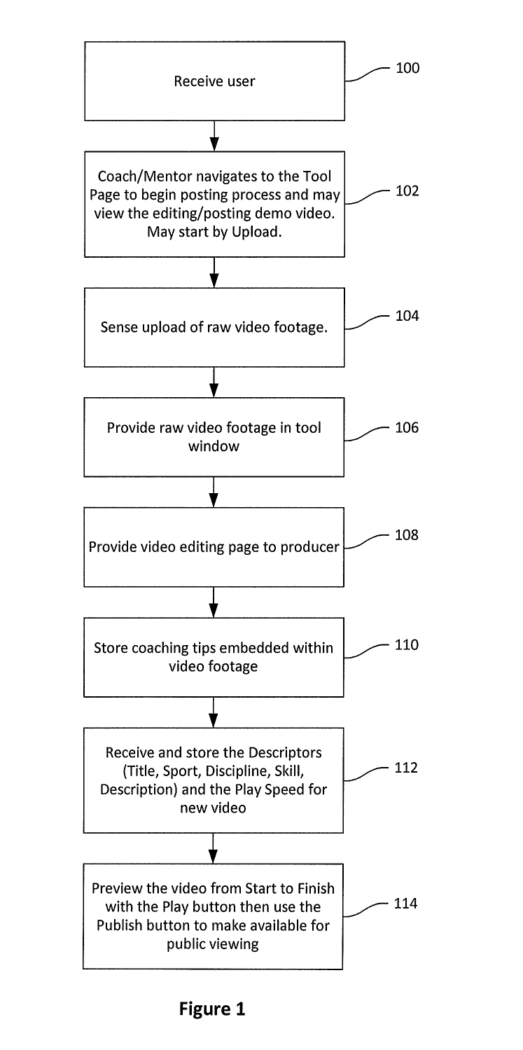

Turning to FIG. 1, a flowchart outlining a method of producing and editing a how-to video is shown. The how-to video can then be stored and accessed by a viewer. Typically, a video producer user has already captured raw video footage which is to be used for the how-to video. The how-to video may also be seen as an online tutorial video. The raw video footage can be captured on any of a multitude of devices, such as, but not limited to, a GoPro™, a smartphone, a tablet and the like. This raw video footage can then be stored on a storage medium associated with the system. The storage medium may be, but is not limited to, a hard drive, a database or the cloud.

In a preferred embodiment, in order to be able to produce, edit and store the how-to video, the producer may have to be registered with the system as a coach or mentor in order to be able to control access to the video or videos created by the producer. This registration process may be handled by the system, or website (100). User registration within a website will be understood by one skilled in the art. User registration information may include, but is not limited to, a user name, a profile picture, a user profile or biography (either in a text or video format), gear information and/or sponsor information. Gear information relates to the type of gear or equipment that the producer, or coach, uses so that viewers may consider purchasing similar equipment since it is somewhat being endorsed by the producer or coach.

During the registration process, each producer may be able to create a profile video to introduce themselves to other individuals registered in the system and to any non-registered individuals accessing the system. The producer may also be subject to a set of terms and conditions as part of the registration process. If necessary, the producer may be provided with a video editing/posting page to learn how to produce, edit and store the how-to video (102).

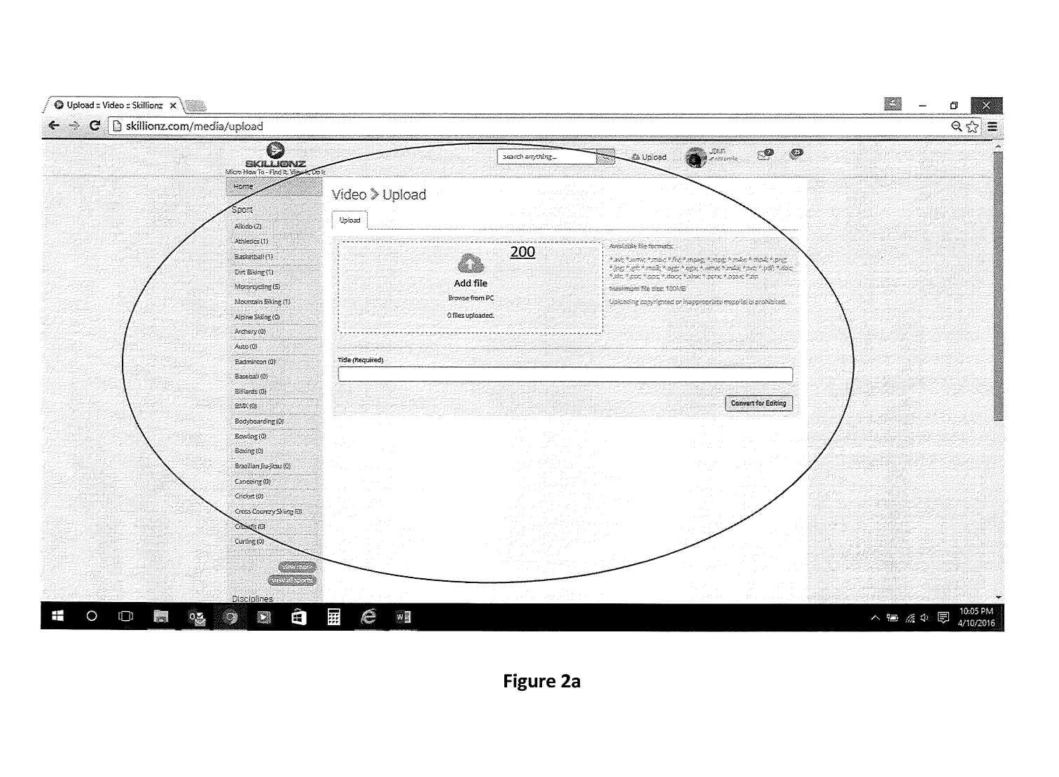

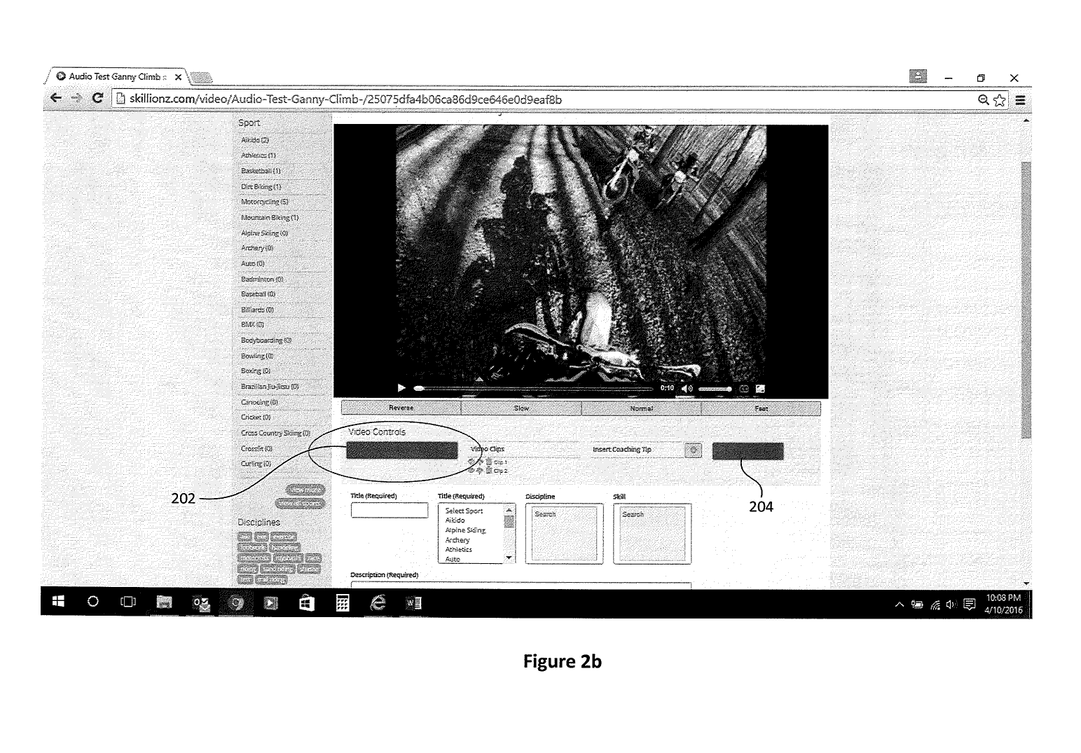

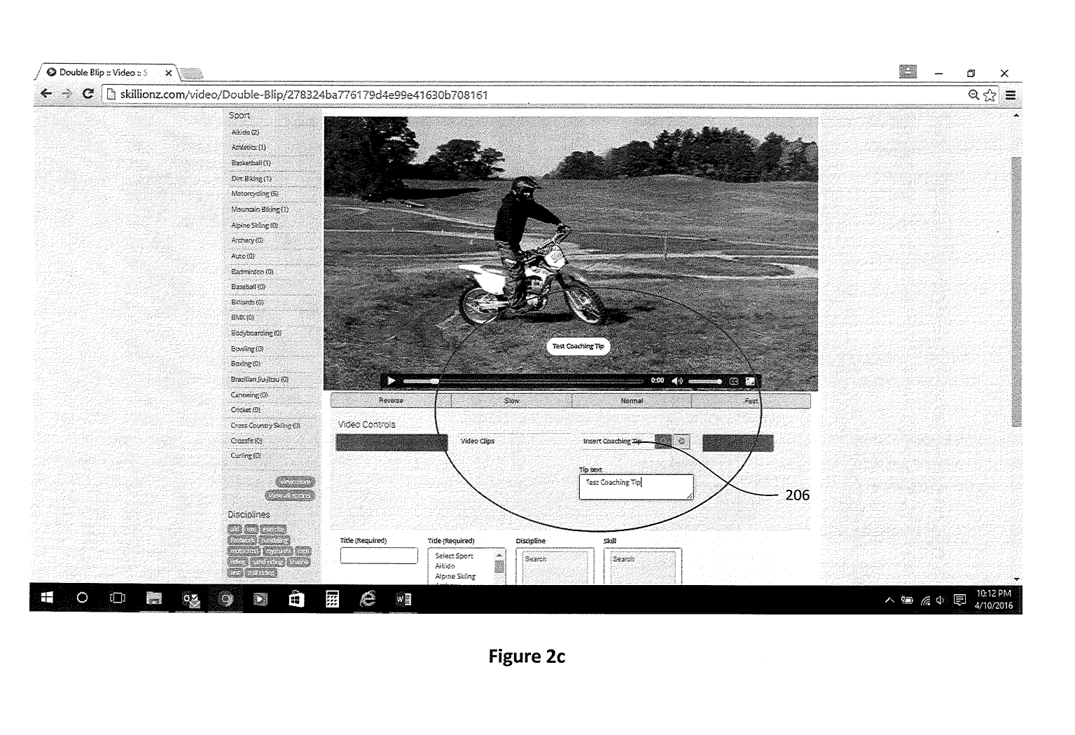

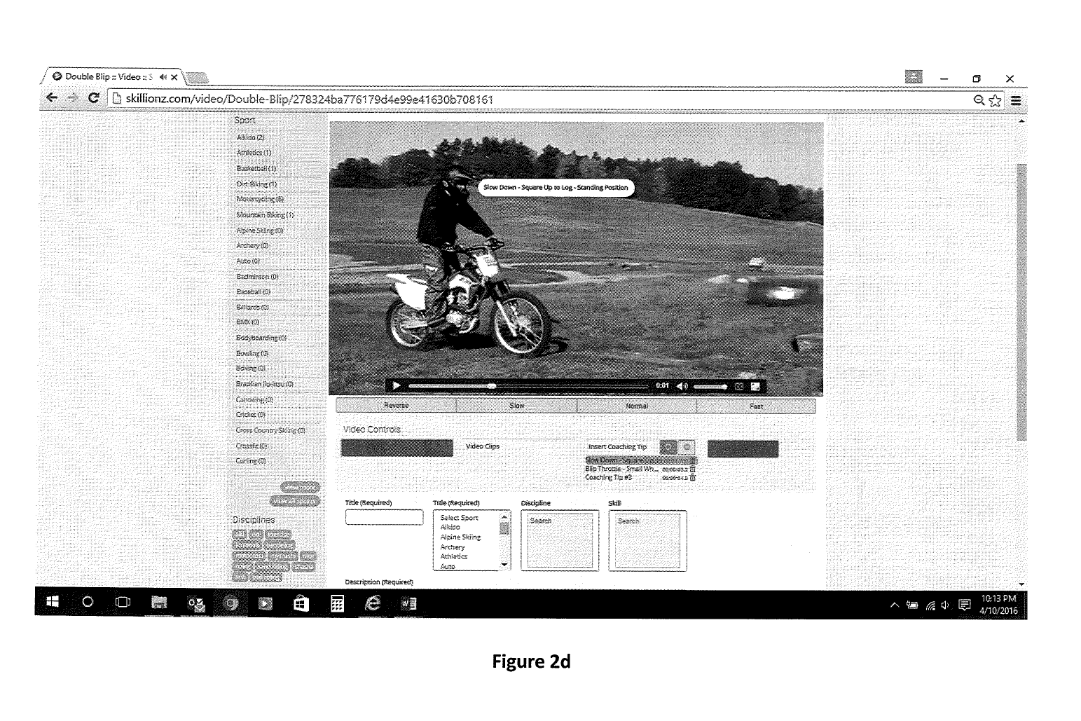

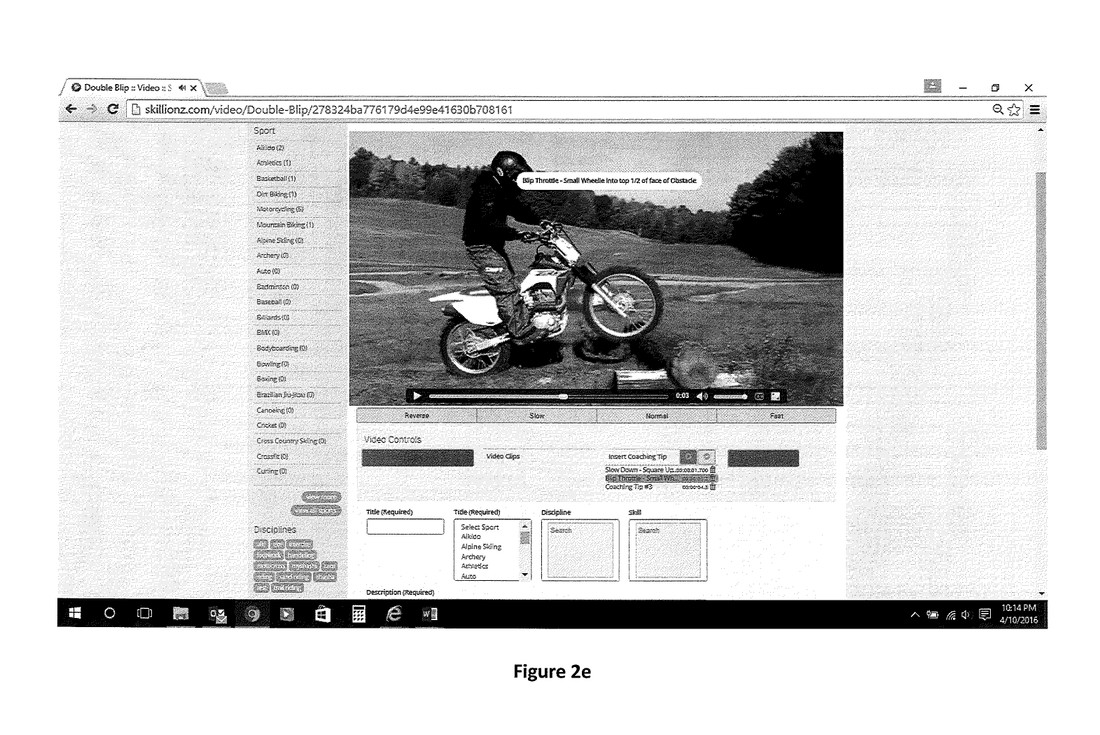

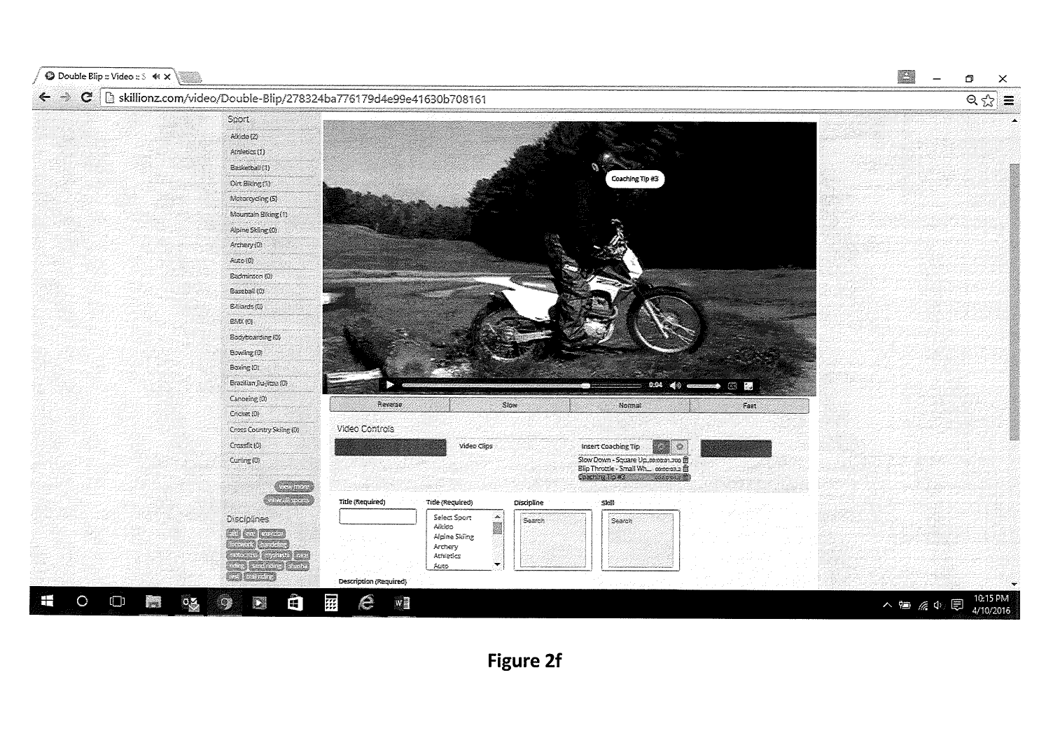

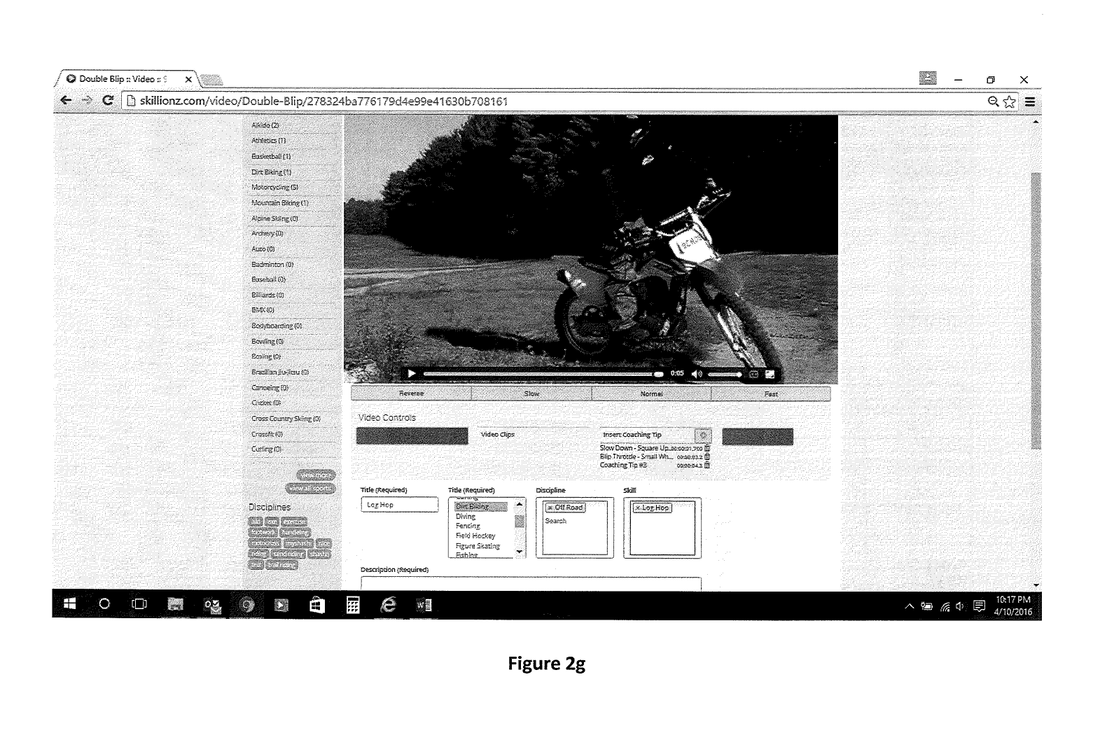

Initially, the producer may select an icon to upload the raw video footage for editing into a how-to video (104) which is sensed by the system. An example of the display screen a user may be presented with is shown in FIG. 2a. When the producer is ready to upload the video, the producer may click an “Add File” button 200 to upload the video as per known methods. Once the system senses that the “Add File” button 200 has been selected, the system executes an add file module in order to retrieve the raw video footage for storage within the system. The add file module will be understood by one skilled in the art.

The system may provide the uploaded raw video footage to the producer in a tool window (106) so that the producer can reduce the size of the raw video footage, if necessary, before the footage is uploaded. In one embodiment, a size restriction for uploaded raw video footage may be included such that the finalized how-to video does not exceed a specific length of time, such as, but not limited to, ten seconds. The system may then provide an indication when the uploading process is completed.

After the raw video footage has been uploaded and stored with the system, the producer is provided an opportunity to edit the raw video footage to produce the how-to video (108). In this editing process, the producer may be able to split the raw video footage into multiple clips using a navigation and/or split video button. The functionality of the split video button allows for the raw video footage to be divided into multiple video clips. Each of these video clips can then be used for an individual how-to video. An example screen shot of what is displayed to a user is shown in FIG. 2b. In one embodiment, the producer may play the raw video footage and then pause the video at a desired location or time within the raw video footage. The producer can then click a “Video Split” or “Split Video” button 202 (which is sensed by the system) which then splits the raw video footage. The producer may continue to split the raw video footage into multiple video clips. After storing the first splitting point, the video may be started again and paused when the producer wishes to split the raw video footage again. After the video is paused and it is sensed that the producer has clicked the Split Video button 202 again, the system stores the subsequent splitting point to define different video clips.

After the producer has completed splitting the raw video footage into the multiple video clips, the producer may then insert coaching tips into the raw video footage. In another embodiment, the producer may select the starting and end points of one or many how-to videos as the raw video footage may be split as many times as desired. Unwanted footage or clips can be discarded leaving only the clips of video which the producer wishes to edit and/or merge. Although not required, the system may also provide the producer with an opportunity to save the how-to video at any point when the work is in progress. It is preferred that raw video footage clips are preferably ten seconds or less when played at 100% speed. This will allow a length of twenty seconds (before edits) if set to play back at 50%.

The video is then furthered edited to include at least one coaching tip (110) (which is embedded within the how-to video and stored by the system) so that when viewers view the how-to video, the viewer is able to obtain a better understanding of the teachings of the how-to video. In one embodiment, in order to insert a coaching tip, the system provides a coaching tip screen (schematically shown in FIG. 2c) to the producer. In order to insert the coaching tip, the producer navigates the video to the time at which the producer wishes for the viewer to see the coaching tip and then clicks on an insert coaching tip button 206. By clicking the coaching tip button 206, a timed, such as 5 seconds, coaching tip pause point is generated and the producer is prompted to insert text to accompany the coaching tip. This inserted text may be seen as an annotation. After the text has been inserted, it may be dragged to a location within the display for placement by the producer. The full coaching tip may then be inserted by clicking an Accept button. After sensing the acceptance of the inserted coaching tip or tips, it is understood that the coaching tips are precisely anchored to a specific video frame and point in time in the how-to video by the system. The exact placement is beneficial to a viewer in breaking down each skill, especially those skills that happen over shorter durations. This may be repeated for other coaching tips. This information is then received and stored by the system. Further examples of coaching tip insertion are shown in the display screen shots of FIGS. 2d to 2f. After the coaching tip or tips have been inserted, the system may save, or publish, the updated how-to video. The annotations and pauses at key moments of the how-to video will assist viewers to break down the how-to video and learn the skill the how-to video is demonstrating.

In a preferred embodiment, the coaching tip (and annotation) will be entered in a video window and then replicated in a text bubble that pops up on the video image. The position, size, location and the pointer of the text bubble can be edited to a location where the producer wishes to place the annotation within the how-to video image. When the how-to video is watched by a viewer, in one embodiment, the how-to video pauses at each “Coaching Tip” for a predetermined period of time and displays the coaching tip (annotation) text.

The producer may then be prompted to insert descriptions for the video which are saved by the system (112). These descriptions may include, but are not limited to, a title (which may be seen as a brief name for the how-to video), the designated sport that the video is associated with, a discipline that is being taught by the video, a skill that is being taught and a brief description of the video. As will be understood, the discipline may refer to a subset of the sport being searched. For instance, if the sport is running, the discipline may be sprinting or jogging. A play speed may also be selected and stored. Finally, the system may provide the producer with a preview (114) of the how-to video before allowing the producer to publish the how-to video for review by others. A schematic screen shot of one embodiment of what is provided by the system to a user is shown in FIG. 2g. The producer can then publish the how-to-video by clicking a Publish button 204. Upon sensing of the publish button click, the system saves the how-to video and stores it in a database so that viewers can search for the completed how-to-video.

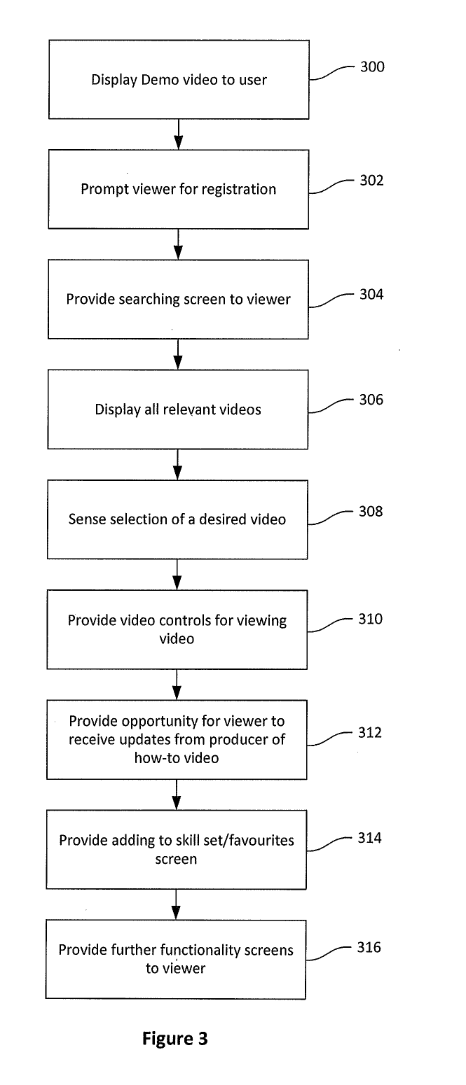

Turning to FIG. 3, a flowchart outlining a method of how a user (such as a student or viewer) interacts with the how-to video created by a producer. In general, the how-to videos which are stored by the producers may be viewed by anyone who has access to the system.

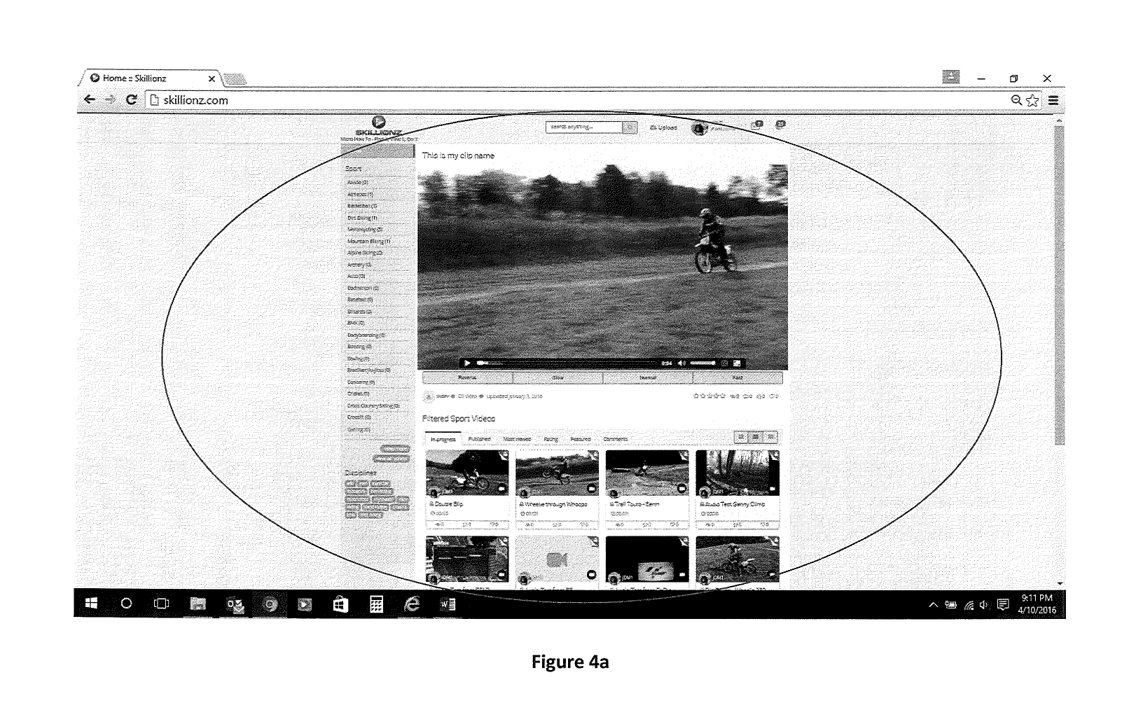

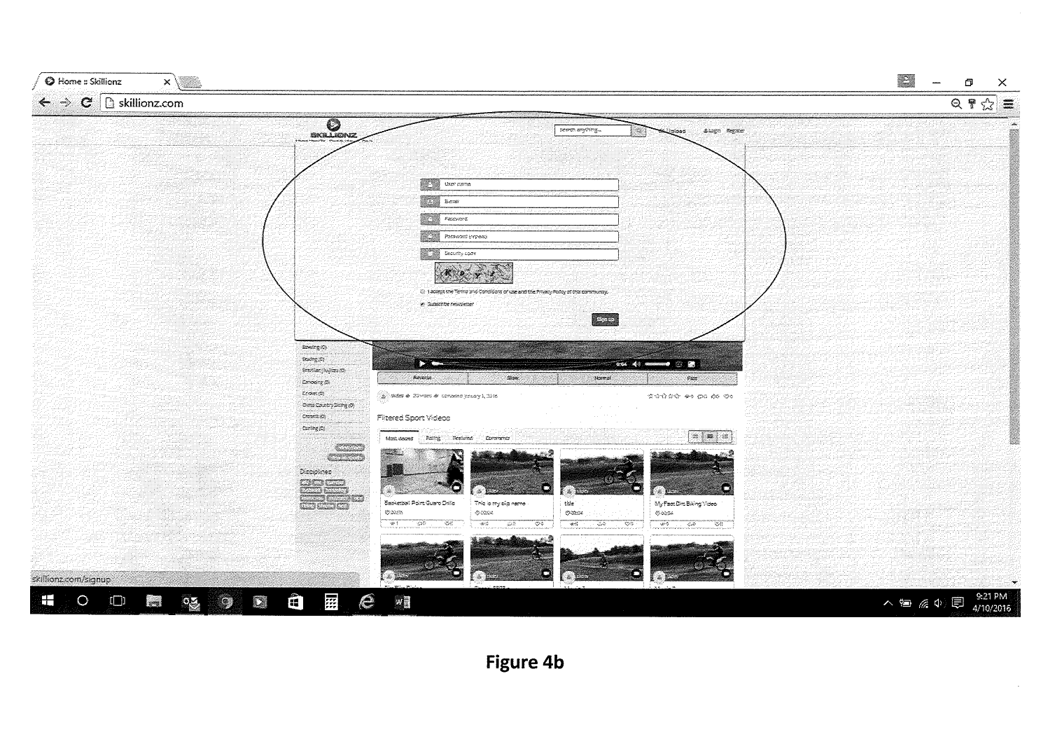

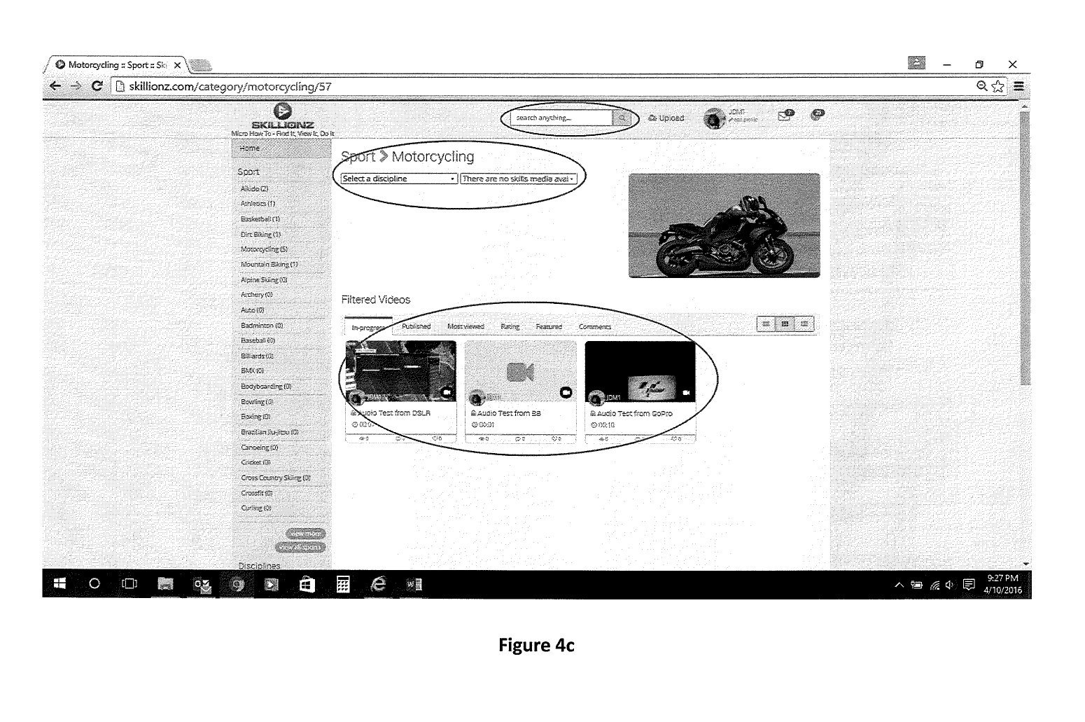

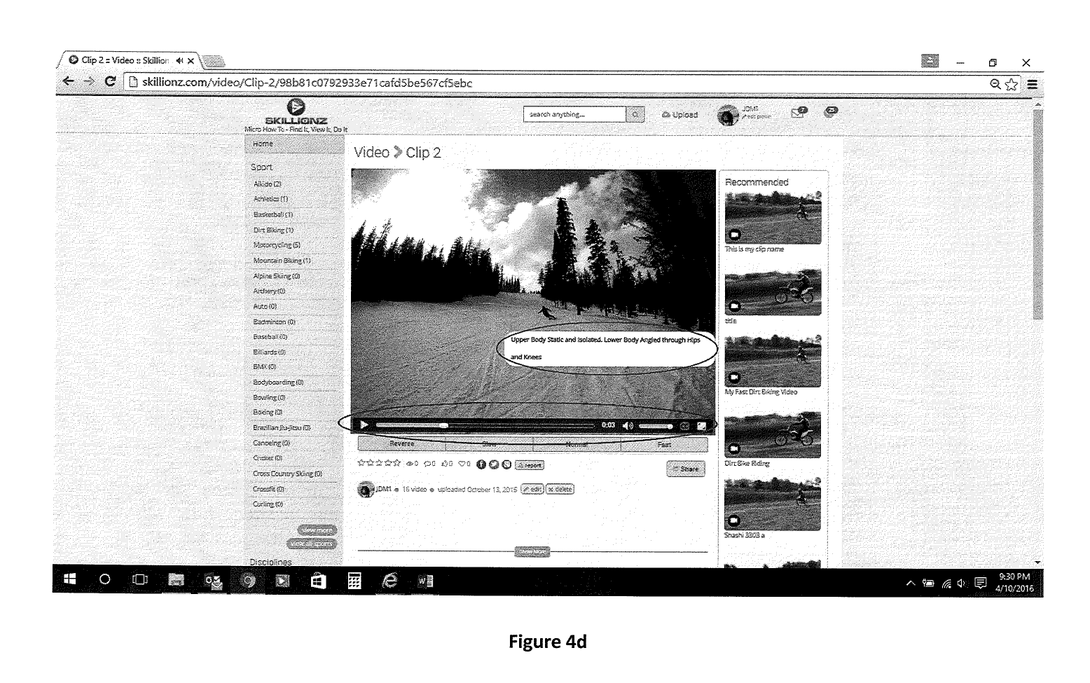

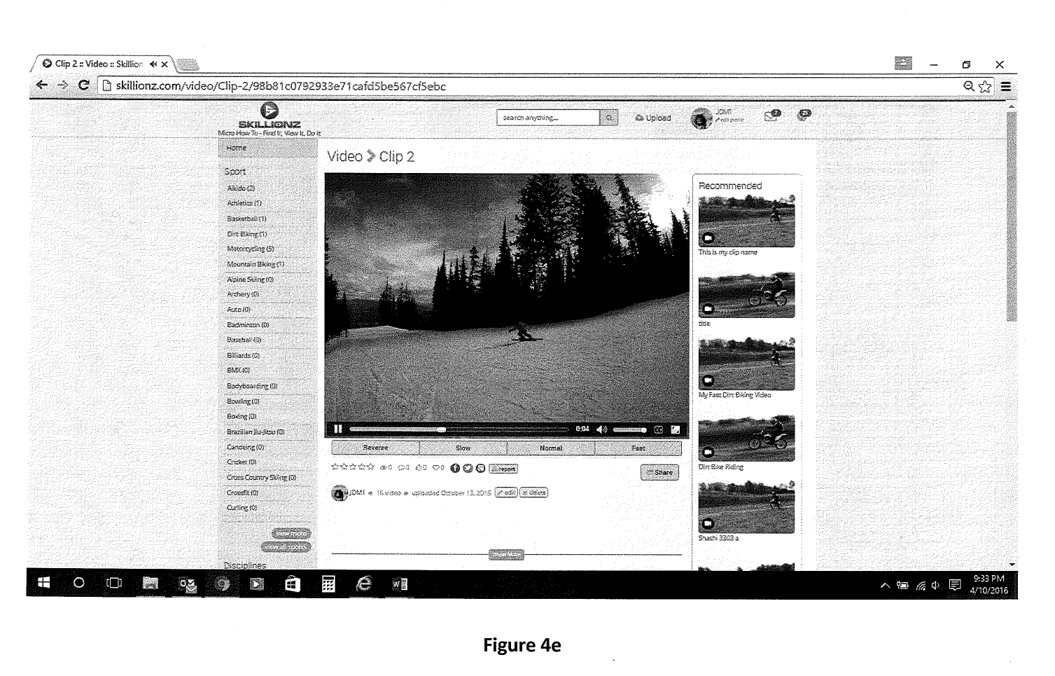

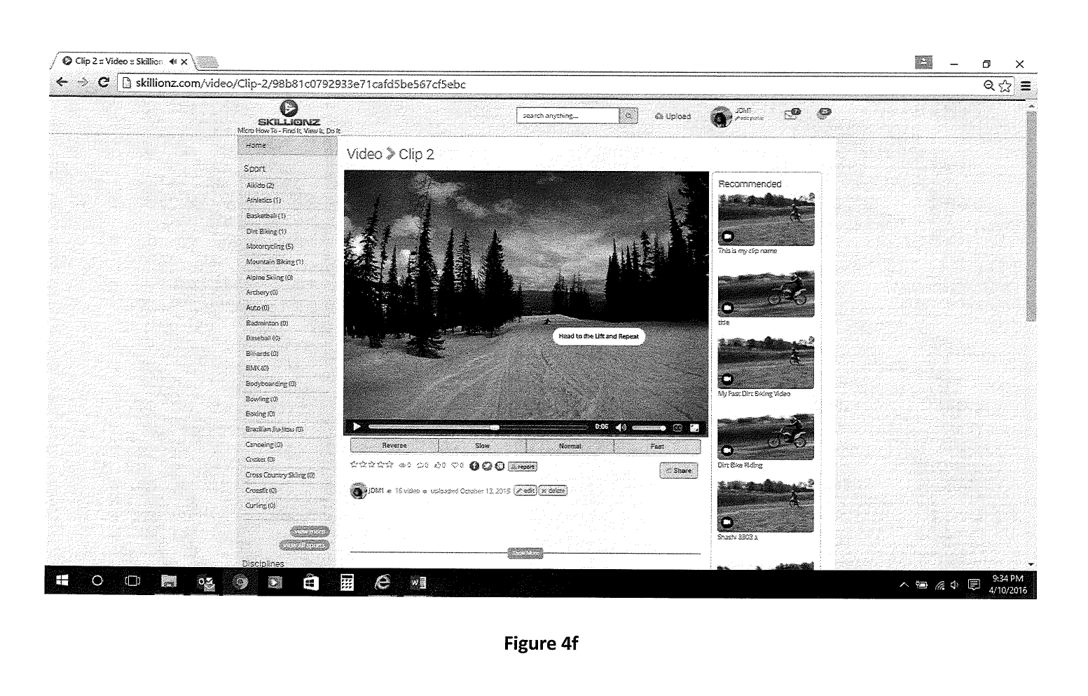

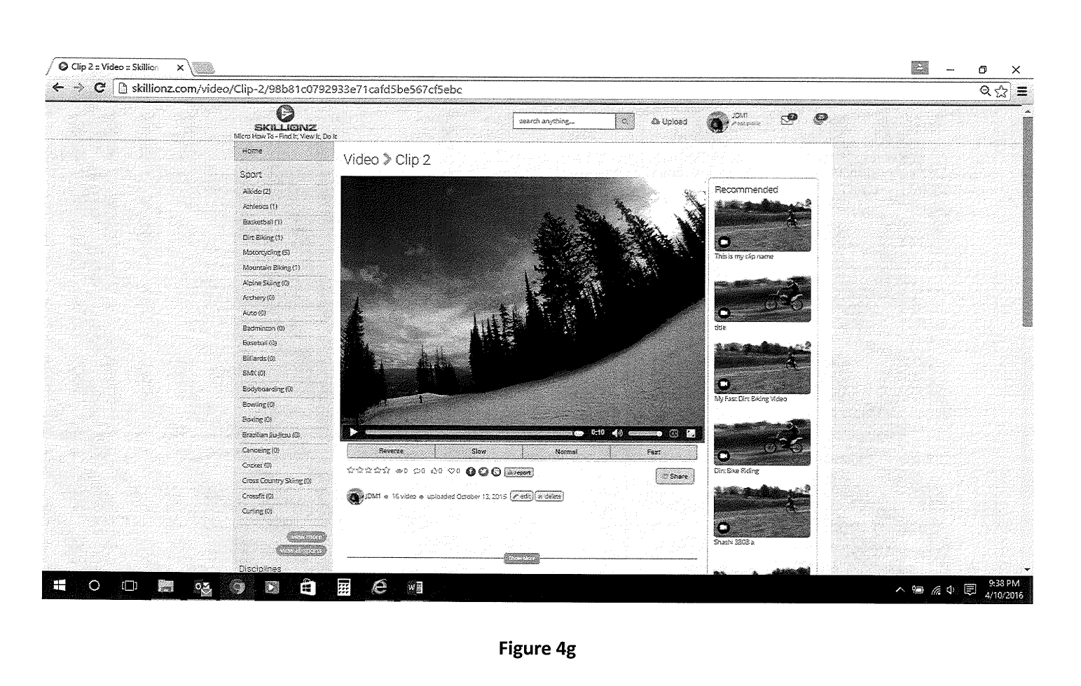

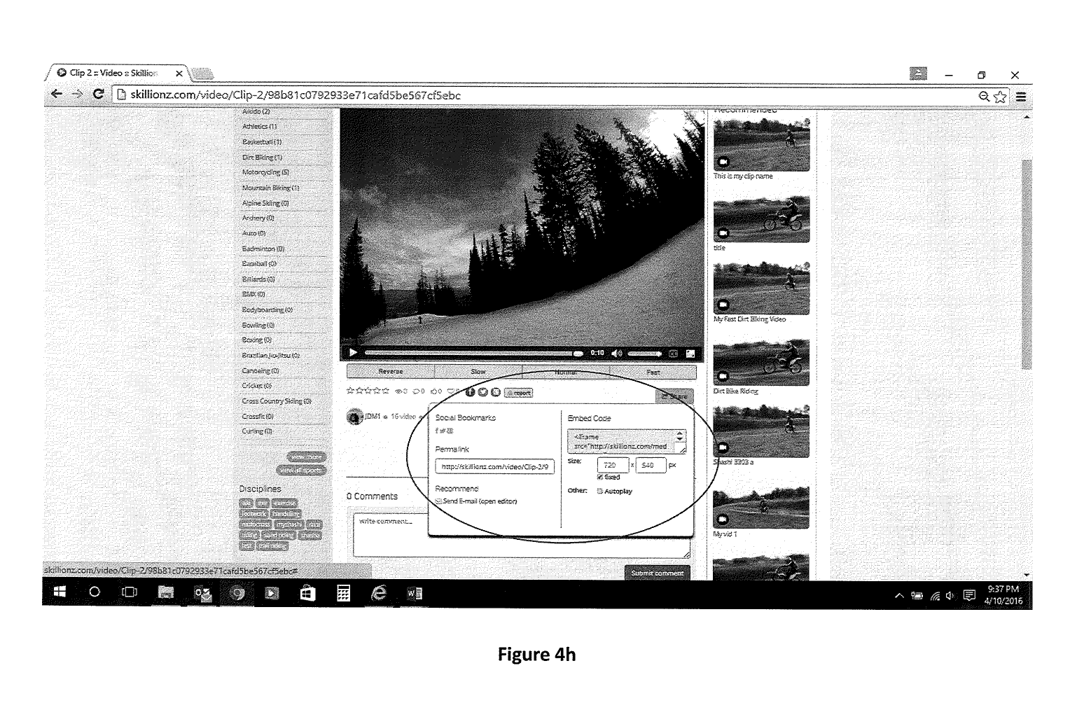

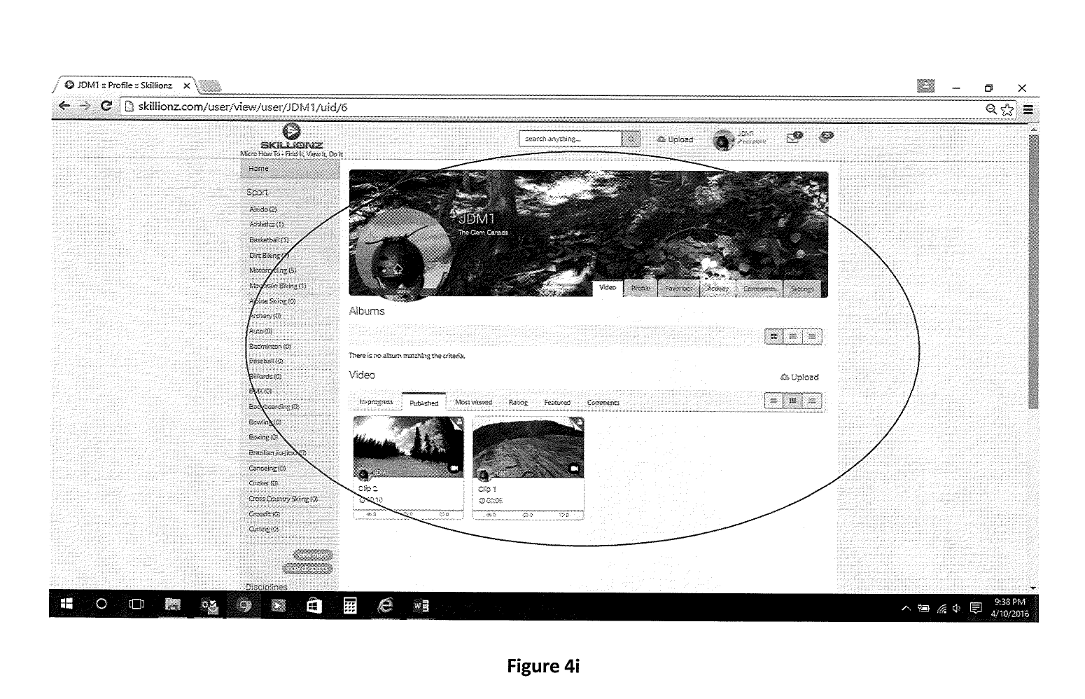

Prior to accessing the how-to video, the viewer may be shown a terms and conditions screen which the viewer is required to accept before being shown the selected how-to video. The viewer may also be shown an introduction or demonstration video (300) by the system. An example display screen is shown in FIG. 4a. While it is preferred that the viewer is registered with the system, the viewer may still be able to retrieve and view the how-to video without being registered. In the preferred embodiment, the system may prompt the viewer to register (302) with the system after they have viewed the introduction video. An example registration display screen is shown in FIG. 4b. Alternatively, the viewer may be prompted to register with the system even without watching or before being shown the introduction video. The introduction video is directed at providing the viewer with an understanding of how to interact with the how-to video display system.

After viewing the introduction video or after registering with the system, the viewer is provided an option to select a sport in which the student wishes to view a how-to video (304). This may be provided by the system to the viewer via a drop-down menu box. The viewer may then be provided other narrowing identifiers such as discipline and skill drop lists. Alternatively, the system may provide the viewer with a free form text box to search for a how-to video.

After sensing the sport selection (and other narrowing identifiers) entered or selected by the viewer, the system displays a list of how-to videos which match the criteria selected by the viewer (306). In one embodiment, this is achieved by having the system compare the selected criteria with the characteristics of the stored how-to videos. Since each how-to video is tagged or categorized with a sport, discipline and skill descriptor, this criteria/categorization is then leveraged in one or many search droplist(s). In one embodiment, after a viewer has selected a desired sport from a droplist, the system provides a related discipline droplist to the viewer. Upon sensing the selection of a discipline, the system provides a skills droplist so that the viewer can select a related skill. In a preferred embodiment, these droplists are dynamically populated based on the previous selection. This assists in narrowing the number of how-to videos that the viewer can select from to a more relevant list based on the searching. Users can also use free form text search that reference the sport, discipline and skill categories. The system may also combine this information with the contents of the title and description fields or a producer/coach's name to further narrow the scope of the search. An example of a display screen provided by the system showing the searching functionality and the retrieved list is schematically shown in FIG. 4c.

The system then senses which of the displayed videos is selected by the viewer and then retrieves the selected how-to video from its storage location (308). The selected video is then delivered to the viewer so that the viewer can watch the how-to video. During the viewing, the system pauses the how-to video at the pre-set coaching tips as previously inserted by the producer.

The system also provides the viewer with controls of the how-to video so that the viewer can engage with the how-to video (310). Example display screens of a video display and video controls are shown in FIGS. 4d to 4f. In one embodiment, the system provides a play/pause function, a play speeds function where the viewer can determine the speed at which they wish to play the how-to video, a drag pointer function which allows the viewer to manually manipulate viewing of the how-to video to proceed as fast or as slow as they wish. The viewer may also use the drag pointer function to reverse the how-to video back and forth. Finally, the system may also provide the viewer with a volume function.

After the viewer has completed watching the selected how-to video, the system provides the viewer with an opportunity to enroll, or sign up, with the producer of the how-to video to receive updates from the producer (312). In one example, when new how-to videos are posted by the producer, the viewer may be updated by the system. If the viewer wises to receive these updates, the viewer must be registered with the system.

The viewer may also be prompted to add a skill set or to select favorite how-to videos (314) by the system. Furthermore, the system may provide other functionality to the viewer (316), such as, but not limited to, an opportunity to assign comments and/or ratings for how-to videos, provide links to other how-to videos provided by the producer, provide a link to the producer's profile page and providing the viewer with an opportunity to share the how-to video on a social media account. An example display screen for providing further functionality to the viewer is schematically shown in FIG. 4h.

If the viewer decides to view the producer's profile page, the system displays a producer profile screen, such as schematically shown in FIG. 4i. If the viewer decides to view a listing of the producer's how-to videos, a how-to video list display screen such as shown in FIG. 4i is provided by the system to the viewer.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method of producing a how-to video comprising:
displaying raw video footage to a producer;
inserting a coaching tip into the raw video footage; and
storing the raw video footage as the how-to video.

2. The method of claim 1 wherein inserting the coaching tip comprises:
sensing request for coaching tip insertion;
transmitting annotation text request;
receiving annotation text; and
storing annotation text as coaching tip within the how-to video.

3. The method of claim 2 further comprising:
sensing location placement of coaching tip within display image of how-to video; and
storing location placement within the how-to video.

4. The method of claim 2 further comprising, before sensing request for coaching tip insertion:
sensing navigation to a specific point in the how-to video.

5. The method of claim 4 further comprising:
inserting a pause in video play at the specific point in the how-to video.

6. The method of claim 1 further comprising:
sensing request for the how-to video from a viewer;
retrieving how-to video from a storage medium; and
displaying how-to video to the viewer.

7. The method of claim 6 further comprising:
displaying a terms and conditions screen prior to displaying the how-to video.

8. The method of claim 1 further comprising:
receiving a list of descriptors associated with the how-to-video; and
storing the list of descriptors with the how-to video.

9. The method of claim 8 further comprising:
receiving a search including the list of descriptors; and
displaying the video as a part of a search results list.

10. The method of claim 1 further comprising:
sensing a first split video command representing a start point of the how-to-video; and
sensing a second split video command representing an end point of the how-to video.

11. The method of claim 10 wherein sensing the second video command represents a start point of a further how-to-video.

12. The method of claim 1 wherein the coaching tip appears as a pop-up bubble.

13. The method of claim 1 wherein the how-to-video is ten seconds or less.

14. The method of claim 1 further comprising:
sensing a pause in raw video footage play; and
sensing a split video command.
